(19) United States
(12) Patent Application Publication
(10) Pub. No.: US 2026/0021976 A1
(43) Pub. Date: Jan. 22, 2026

(54) APPARATUS FOR UNLOADING INSULATING GLASS PANELS FROM A PRODUCTION LINE, PLANT COMPRISING SUCH AN APPARATUS AND PROCESS FOR UNLOADING INSULATING GLASS PANELS FROM A PRODUCTION LINE

(71) Applicant: FOREL S.P.A. UNIPERSONALE, Roncade (Treviso) (IT)

(72) Inventors: Fortunato VIANELLO, Roncade (Treviso) (IT); Riccardo VIANELLO, Roncade (Treviso) (IT)

(21) Appl. No.: 18/875,471

(22) PCT Filed: Jun. 14, 2023
(86) PCT No.: PCT/IB2023/056141

§ 371 Date: Dec. 16, 2024

(30) Foreign Application Priority Data
Jun. 17, 2022 (IT) 102022000012881

(51) Int. Cl. B65G 49/06; E06B 3/673

(52) U.S. Cl. CPC B65G 49/063; B65G 49/061; B65G 49/068; E06B 3/67365; B65G 2201/022

(57) ABSTRACT

Provided is an apparatus for unloading insulating glass panels from a production line having an insertion device provided with a conveyor adapted to transport the insulating glass panels according to a transit direction from an entrance area close to the production line to an exit area for the insulating glass panels. The apparatus has a vertical support structure for keeping the insulating glass panels in an inclined position with respect to a vertical direction. The insertion device has a positioning device adapted to position separating elements above the conveyor so that the separating elements can be interposed between the insulating glass panels and the conveyor.

### FIELD OF APPLICATION

The present invention relates to an apparatus for unloading insulating glass panels from a production line, a plant comprising such an apparatus, and a process for unloading insulating glass panels from a production line.

### BACKGROUND ART

Insulating glass commonly means the set of two or more facing glass sheets separated by a specific spacer so as to form one or more gaps, possibly filled with gas other than air, therebetween and to create, along the periphery, the housing for a sealing material.

As is known, highly automated insulating glass production lines generally consist of several machines in which the end ones consist of the following automatic machines: spacer profile applier to form the spacer frame; coupler, gas loader, press; and sealing machine.

The movement of the insulating glass panels (hereinafter also referred to as “panels”) being processed occurs in vertical, or “almost vertical”, position, the glass panels being generally placed at 6° with respect to the vertical direction.

At the end of the production process, the manufactured items are usually unloaded from the production line manually or by means of appropriate aids if the weight of the panels does not allow the operator(s) to perform the operation directly.

After being unloaded from the production line, the insulating glasses are placed in appropriate carriages or stands for the period of time required for the catalysis of the secondary sealant before being moved to the next production departments or shipped to customers.

Another operation usually required after the unloading from the production line is the reorganization of the panels according to the orders that generated the production thereof. Indeed, very often, in terms of line productivity and previous production process organization, it is convenient to consolidate the production of items belonging to different customer orders, for example as a function of the features of the glass to be used, the type and thickness of the spacer, or the type of secondary sealant. Therefore, at the end of production, the insulating glass belonging to the same customer order must be grouped together to be prepared for shipping.

It is highly advantageous to automate and computerize such a reorganization operation, as can easily be understood, in terms of labour cost reduction, operator safety, and production space occupation.

Another problem known to those skilled in the art occurs when a thermoplastic-type spacer is used. In this case, as long as the secondary sealant has not reached an adequate level of catalysis, the panel is not capable of withstanding mechanical stresses and could be deformed, resulting in a non-conformity of the required geometrical requirements. Such a feature results in the need to constantly support the glass sheets forming the panel.

Such a phenomenon is also common to other types of spacer, especially in the case of panels with three glass sheets, for which it is always convenient to adequately support both the outer glass sheets and the middle glass sheet. Indeed, when used with a rigid spacer, the primary butyl sealant also has the problem of the sliding of the glass sheet which is not adequately supported from the bottom.

Again, with reference to when a thermoplastic-type spacer is used, in the storage operations on stands inclined by a few degrees (generally from 4 to 6 degrees) with respect to the vertical direction, the practice of positioning several panels adjacent to one another must be avoided because the compression undergone by the first panels stored causes the unacceptable deformation thereof, with the obvious approaching of the glass sheets forming the panel.

For these reasons, there is a need to automate the unloading of the insulating glass panels from the production line, the storage and reorganization thereof, in order to group the items together based on the provisions of the respective customer order. Moreover, in the case of a thermoplastic spacer, it is advantageous to arrange each panel individually, avoiding the superposition with other panels, at least for the time required for the catalysis of the secondary sealant.

In the search for a possible solution to these needs, the prior art has thought to apply what is already being used for glass sheets which, after the cutting step, are to be sorted to the subsequent production lines, such as the insulating glass production lines, or the grinding and/or drilling lines, the tempering lines, etc. Such types of systems and machines are well known and described in several documents, for example, in U.S. Pat. No. 5,511,671A, where a system is described, which withdraws glass panels from a horizontal cutting line, orients them in a vertical direction, transfers them by means of a shuttle into storage modules in a reorganized manner, and then withdraws them and provides them to the subsequent production departments.

However, in addition to the obvious adaptation needs as a function of the different dimensions and weights involved, the use of already known systems for automating the movement, storage, and reorganization of the products after the insulating glass production line, has the problems described below.

In practice, e application of the secondary sealant cannot always be accurate to the point of preventing the support systems on which the insulating glass rests from coming into contact with the sealant that has not yet catalysed. As a result of an inadequate catalysis level being reached, the sealant, of any kind, is sticky and thus soils the parts designed to support from below and transport the insulating glass. Over time (generally, a few hours depending on the environmental conditions and the nature of the product used), the secondary sealant changes from the conventional consistency of a toothpaste to a much greater one with the ability to strongly adhere to the transport devices. The situation worsens as the production continues and subsequent small, but numerous, amounts of sealant settle on the transport means.

A solution to such a problem was suggested in EP 0 671 534 B1, where the application of a belt in the lower part of the insulating glass is described, in order to prevent the recently-applied sealant from coming into contact with the transport and support elements. Although such a solution is effective in terms of preserving the integrity of the support and transport systems, in certain cases it has the drawback of preventing the correct catalysis of the secondary sealant, especially for those materials which react with the moisture in the air. Also the use of permeable belts does not always avoid the slowing of the process either. Such risks are not accepted by insulating glass manufacturers and are tolerated even less by sealing material manufacturers: indeed, an incorrect use of catalysis jeopardizes the functionality and durability of the finished product. Moreover, the belt needs to be manually removed prior to the installation of the insulating glass, thus generating waste and an increase in production costs. Moreover, the width of the belt also needs to be calibrated according to the overall thickness of the insulating glass panel, making the automation complex due to the application thereof.

### OVERVIEW OF THE INVENTION

The need is thus felt to solve the drawbacks and limitations mentioned with reference to the prior art.

Therefore, the need is felt to provide an apparatus and process for unloading insulating glass panels from a production line, which allows making the step of unloading and transporting the panels more efficient once they have been assembled and sealed.

Moreover, the need is felt for an apparatus and process allowing a certain flexibility as for the management of production, freeing it from the several restrictions which must be currently considered, and a rational management of all steps downstream of the process up to the shipping or delivery to another department for subsequent processing.

Again, the need is felt to prevent injuries by increasing the automation of the operations and reducing the exposure of operators to risk.

Such needs are at least partially met by an apparatus for unloading insulating glass panels from a production line according to claim 1, a plant according to claim 21, and a process for unloading insulating glass panels from a production line according to claim 22.

### DESCRIPTION OF THE DRAWINGS

Further features and advantages of the present invention will be more comprehensible from the following description of preferred embodiments thereof, given by way of non-limiting examples, in which:

FIG. 1 diagrammatically shows an axonometric view of a possible embodiment of an apparatus according to the present invention;

FIGS. 2 to 10 each diagrammatically show a sequence of certain steps of a process according to a possible embodiment of the present invention;

FIG. 11 diagrammatically shows an axonometric view of a possible embodiment of a portion of the apparatus according to the present invention;

FIG. 12 diagrammatically shows an element of the apparatus according to a possible embodiment of the present invention;

FIG. 13 diagrammatically shows a side view of a portion of an apparatus according to a possible embodiment of the present invention;

FIGS. 14 and 15 diagrammatically show a possible construction of a portion of apparatus according to a possible embodiment of the present invention; and

FIG. 16 diagrammatically shows a possible step of the process according to an embodiment of the present invention.

Elements or parts of elements common to the embodiments described below will be indicated by the same reference numerals.

### DETAILED DESCRIPTION

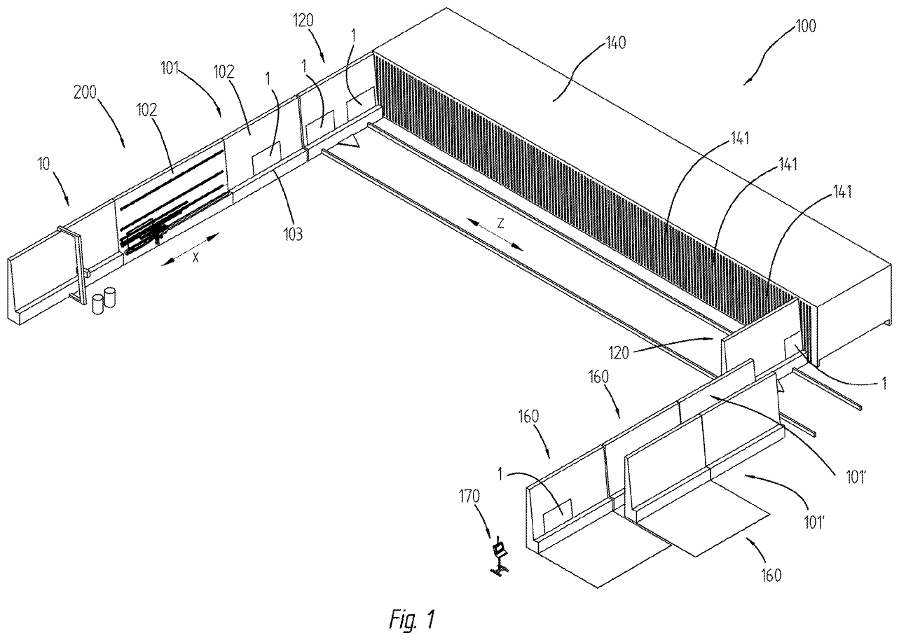

In FIG. 1 it is indicated by reference numeral 100 an apparatus for unloading insulating glass panels 1 from a production line 10.

The apparatus 100 can be used to unload the insulating glass 1 from the production line and to transport, store and reorganize it.

In essence, the apparatus comprises an insertion device 200 provided with a conveyor 202 adapted to transport insulating glass panels 1 according to a direction x from an entrance area close to a production line 10 to an exit area for said panels; and a vertical support structure 102 for keeping the insulating glass in an inclined position with respect to the vertical direction. The inclination can be of about 6°, for example.

The insertion device 200 comprises a positioning device 205 adapted to position rigid separating means 201 above said conveyor 202 so that they can be interposed between the insulating glass panels 1 and the conveyor 202.

According to a possible embodiment, the device 200 comprises handling means 204 for the conveyor 202 between a transport position for said panels and a lowered position with respect to the previous one, for inserting separating means 201 by means of the positioning device 205.

The handling means 204 can comprise an electric, electro-pneumatic, pneumatic, hydraulic and/or combined lift cylinder.

The solutions and details, such as the type of motorisation of the conveyors, for example, which are known to those skilled in the art, are not described in detail in order not to make the reading unnecessarily difficult.

According to a possible embodiment, the positioning device 205 can comprise:
a support plate 212, on which a plurality of separating means 201 can be positioned side-by-side and substantially oriented parallel to the transit direction x of the panels 1; and
a shaped upper plate 209 provided with at least one longitudinal seat 214 facing the support plate 212, adapted to contain at least partially at least one separating means 201, adapted to be moved:
(a) closer to and farther from the support plate 212 to engage at least one separating means 201 on command; and
(b) in a transverse direction above the support plate 212, to move the at least one separating means towards the conveyor 202.

The positioning device 205 can comprise actuating means 207, 208 which allow movements (a) and (b).

According to a possible embodiment, the insertion device 200 can comprise an automatic loader 203 adapted to automatically feed the positioning device 205.

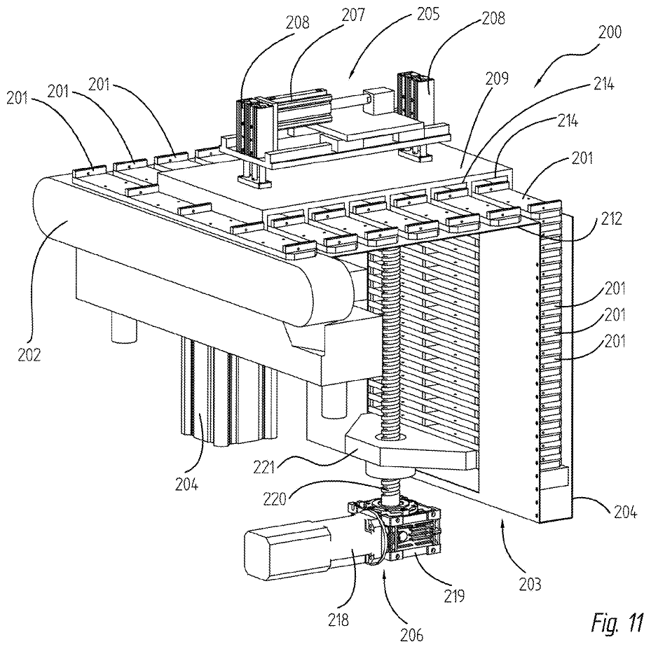

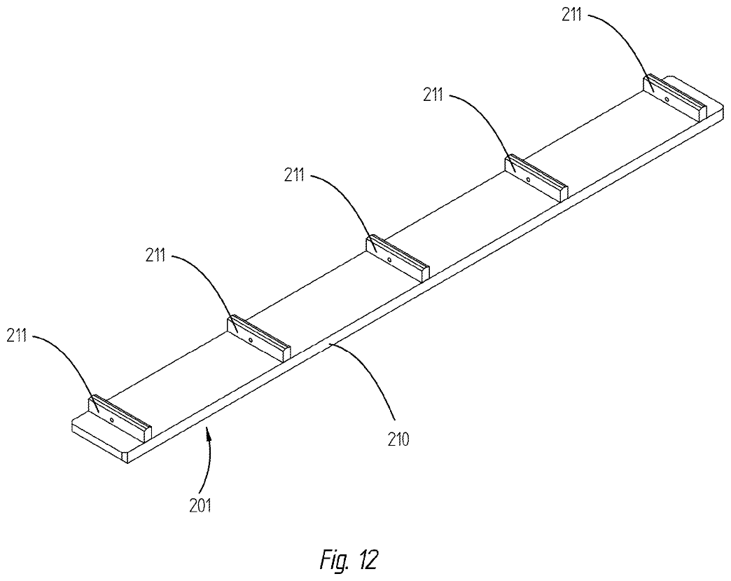

As shown in FIG. 11, the automatic loader 203 can comprise handling means 206 comprising a motorisation 218 connected to a reducer 219 which drives a worm screw 220, adapted to move a loader support 221 on which separating means 201 can be stacked so that the stack of separating means 201 can be lifted to bring the next one to the height of the support plate 212 to be translated by the positioning device 205.

In the circumstance shown in FIG. 11, the conveyor 202 is in the lowered position, ready to be lifted by cylinder 204 to the lifted position thereof and for inserting the separating means 201 between the insulating glass 1 and the conveyor 101 (not shown in this figure).

According to a possible embodiment, the vertical support structure 102 of the insertion device 200 comprises a carriage 300 with coupling means 303, preferably a plurality of suction cups. The travel of carriage 300 can extend upstream and downstream of the insertion device 200.

The apparatus 100 can comprise a storage module 140 for the insulating glass panels 1 coming from the insertion device 200, comprising a plurality of panel warehouses 141, arranged along a direction z, for example, but not necessarily, perpendicular to direction X.

According to a possible embodiment, the apparatus 100 can comprise:
at least one conveyor 101 adapted to receive insulating glass panels 1 from the insertion device 200 and adapted to be moved according to a direction x;
at least one shuttle 120 adapted to receive insulating glass panels 1 from the at least one conveyor 101 and serve the storage module 140, the at least one shuttle 120 being adapted to translate in front of the panel warehouses 141 along direction z; and
at least one withdrawal conveyor 101′ adapted to receive insulating glass panels 1 from the at least one shuttle 120.

The shuttles 120 can receive the insulating glass 1 from the conveyors 101 and can carry out the transverse transport along direction z to insert the insulating glass 1 into the storage module 140, or withdraw it therefrom to place it on one of the conveyors 101′ towards the unloading area.

According to a possible embodiment, the apparatus 100 can comprise at least one unloading conveyor 160 comprising retaining means 400 for detaching the separating means 201 from the insulating glass panel 1 before removing it from conveyor 160.

The conveyors 160 are used for the operations of unloading the insulating glass 1 from system 100 and to arrange it on stands for shipping or whatever is provided for this purpose.

The unloading conveyor can comprise retaining means 400 provided with at least one parallel pneumatic gripper 402 adapted to actuate jaws 401 for retaining the separating means 201 when lifting the insulating glass panel 1, for the detachment from the separating means 201. In this way, after any cleaning and maintenance operations, the separating means 201 can be reused.

According to a possible embodiment, the separating means 201 can comprise a substantially rectangular elongated element 210 provided with support inserts 211 adapted to support at least one insulating glass panel 1.

Advantageously, the elongated element 210 can be made of a polymer material, preferably PVC (polyvinyl chloride), and/or the support inserts 211 can be made of a polymer material, preferably nitrile rubber (NBR).

The elongated element 210 can be made by coupling two different materials: a lower layer with a high friction coefficient, preferably nitrile rubber, the upper one made of non-stick material, preferably Teflon; even more preferably, an insert can be interposed between the two layers of material, which is adapted to give the separating means 201 the necessary mechanical stiffness features.

The apparatus (100) can comprise side wheels 105, 106 for laterally guiding the separating means 201 when transiting on the conveyors 101, 101′, 160.

According to a possible embodiment, the apparatus 100 can comprise means (not shown) for applying a non-stick substance at said separating means 201, in particular at said support inserts 211, prior to the use thereof.

According to a possible embodiment, the apparatus 100 can comprise a programmable control unit 170 operatively connected to the drives of apparatus 100 for the management of the movements of the components thereof.

The control unit 170 can be used to manage all system operations to ensure the adequate residence time period of the insulating glass 1 in the storage module 140 in order to respect the catalysis or curing times of the sealing products prior to shipping and to reorganize them based on the customer orders being shipped.

The present invention further relates to a plant comprising an insulating glass production line 10 and an apparatus for unloading insulating glass panels 1 as described above.

The process for unloading insulating glass 1 from a production line 10 comprises the steps of:
(a) providing an apparatus for unloading insulating glass panels from a production line as described above;
(b) positioning a separating means 201 above the conveyor 202;
(c) advancing the insulating glass 1 above the separating means 201; and
(d) advancing the insulating glass 1 supported by at least one separating means towards the conveyors 101.

According to a possible embodiment, the process comprises:
a step (b′) before step (b), in which the conveyor 202 is positioned in the lowered insertion position of said separating means 201; and
a step (c′) after step (c), in which the conveyor 202 is lifted to the transport position thereof up to bringing the separating means 201 into contact with the lower part of the insulating glass panel 1.

According to a possible embodiment, the insulating glass panel is supported by the coupling means 303 of carriage 300 during the transit of the insulating glass panel 1 on conveyor 202.

Advantageously, at least one further separating means 201 can be inserted between the conveyor 202 and the insulating glass 1, through the repetition of steps (b) and (c), and possibly also of steps (b′) and (c′). The process can comprise a step of applying a non-stick substance to the separating means 201. In this way, maintenance and cleaning of the separating means 201 can be facilitated. Generally, such substances are in liquid form, therefore they can be easily sprayed or applied by contact with appropriate sponges previously soaked.

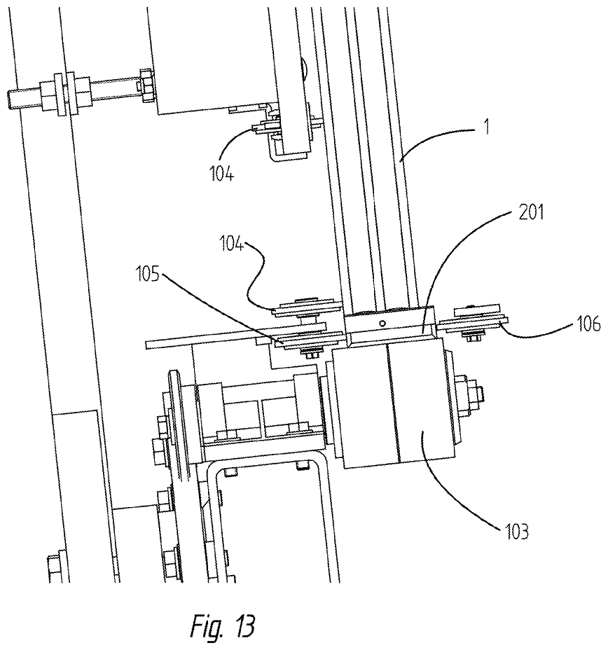

FIG. 13 shows a side view of a detail of the conveyors 101 or 101′. When transiting on conveyor 101, the insulating glass 1 is supported on the vertical plane by the vertical structure 102 by means of wheels 104. Two other series of wheels, 105 and 106, referred to as the inner and outer wheels, respectively, laterally guide and allow the separating means 201 to be kept in the correct position during the movement along the conveyors 101 and 101′ and in the storage module 140.

As shown in the description above, the separating means 201 remain(s) matched with the insulating glass during all the movements required in system 100 and transmit, by friction, the motion they receive from the conveyors of system 100 to the insulating glass 1. Thereby, the secondary sealant, in the non-catalysed or unhardened and sticky state, does not come into contact with the movement members, but only with the separating means. The separating means 201 are removed only after the stop in the storage module 140 for the time required to make the sealant non-soiling for the transport members.

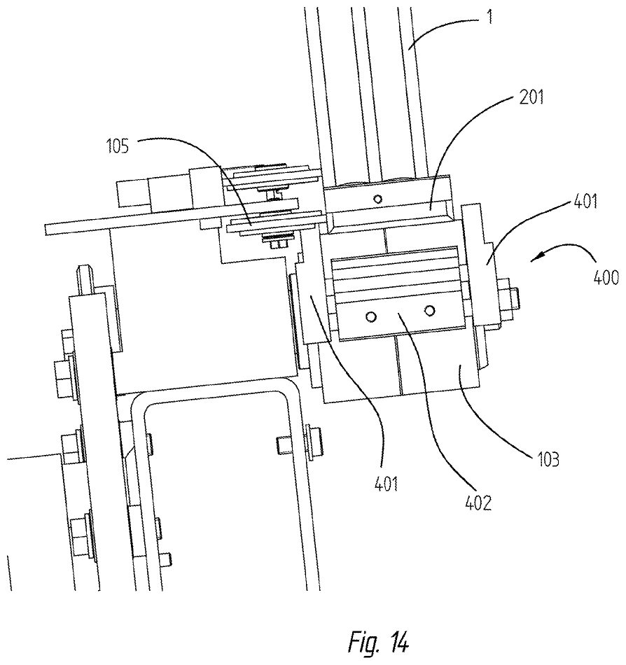

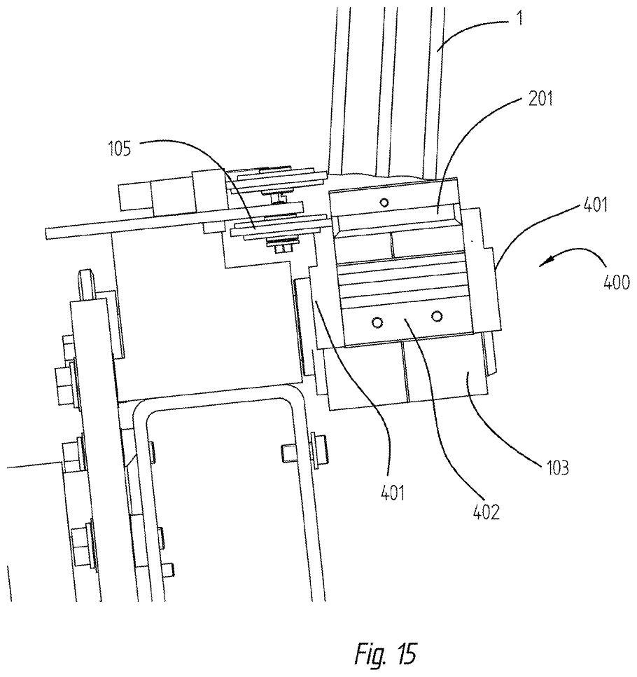

FIG. 14 shows a side view of the retaining device 400 for the detachment of the insulating glass 1 from the separating means 201. These devices are arranged at the unloading conveyors 160, i.e., where the insulating glass joins the secondary sealant conveniently catalysed and/or hardened and thus made non-soiling. Specifically, in FIG. 14, the transport kinematic system 103 consists of cylindrical rollers. Such a configuration allows the retaining device 400 to be accommodated in the gap between one roller and the next one. The insulating glass 1 rests, with the lower edge thereof, on the separating means 201, which in turn rests on the transport kinematic system 103. A parallel pneumatic gripper 402 actuates the jaws 401, which are shown in open position in FIG. 14. In FIG. 15, said jaws 401 are in closed position to retain the separating means 201. At this point, the insulating glass 1 can be lifted to achieve the detachment from the separating means 201. It can be convenient, prior to lifting, to rotate the insulating glass 1 about the lower corner thereof (operator side), as shown in FIG. 15.

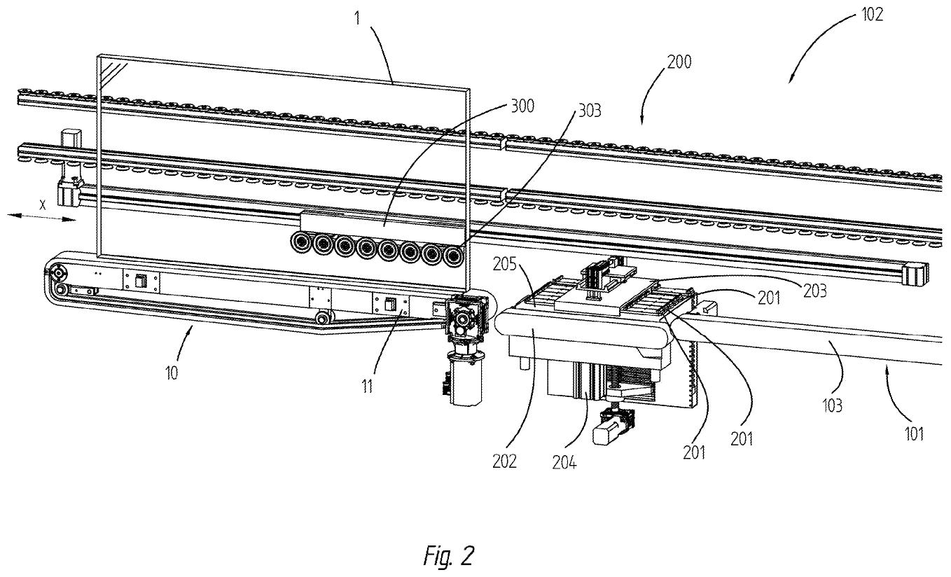

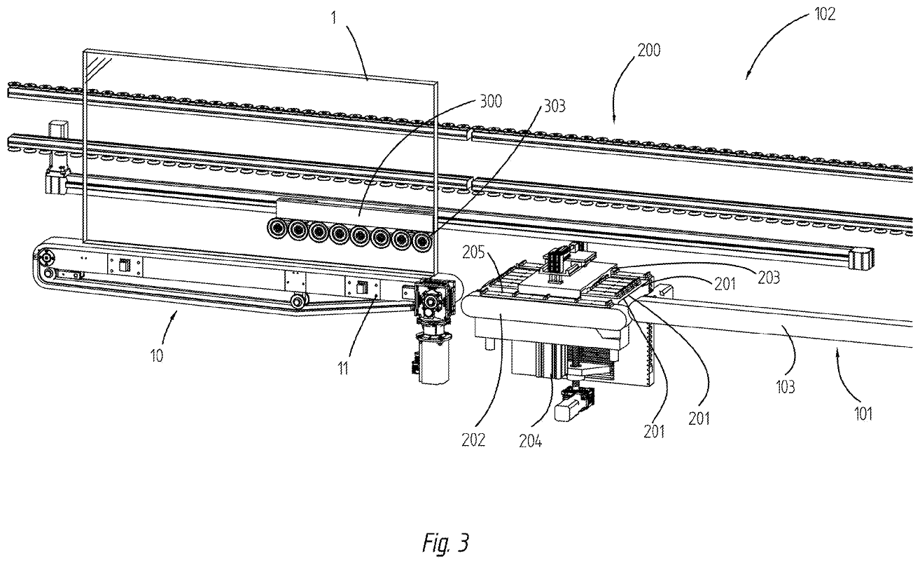

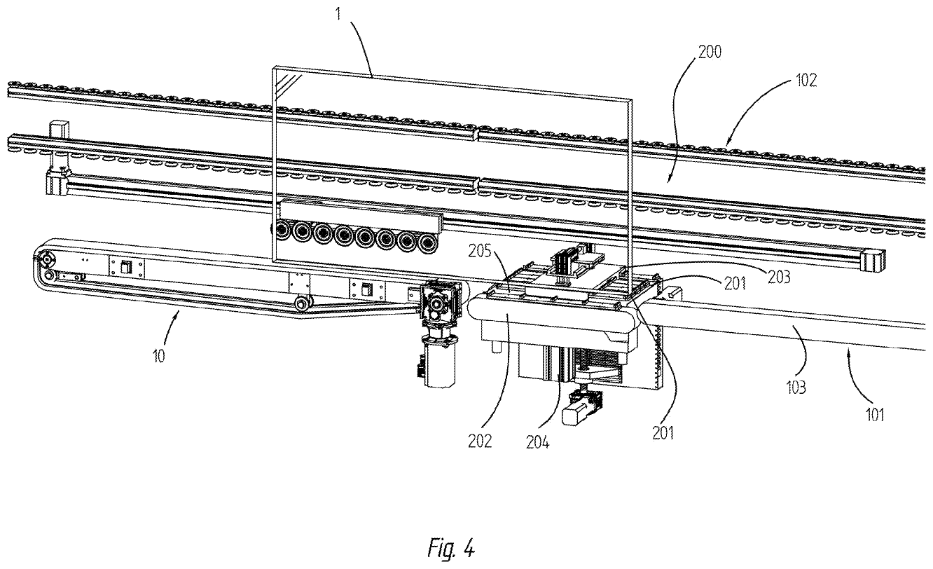

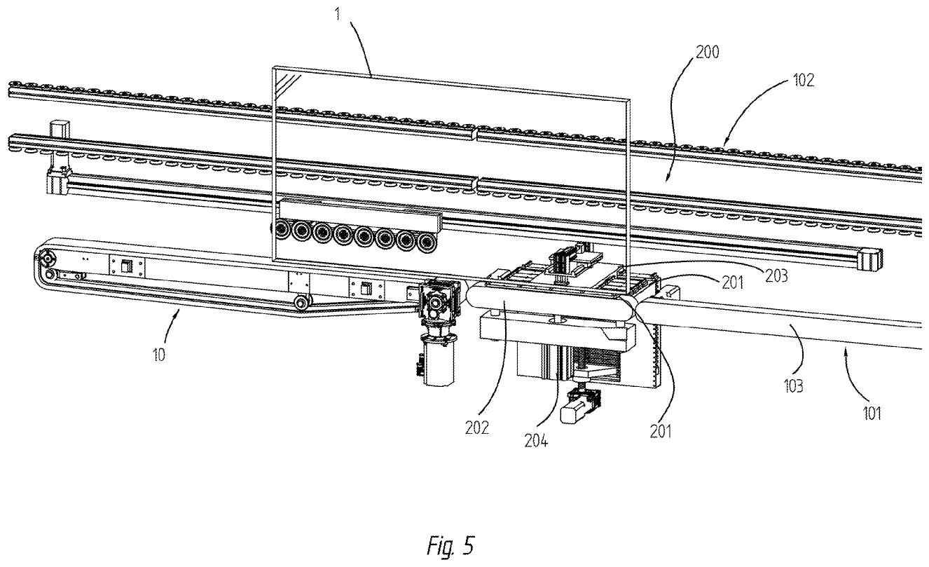

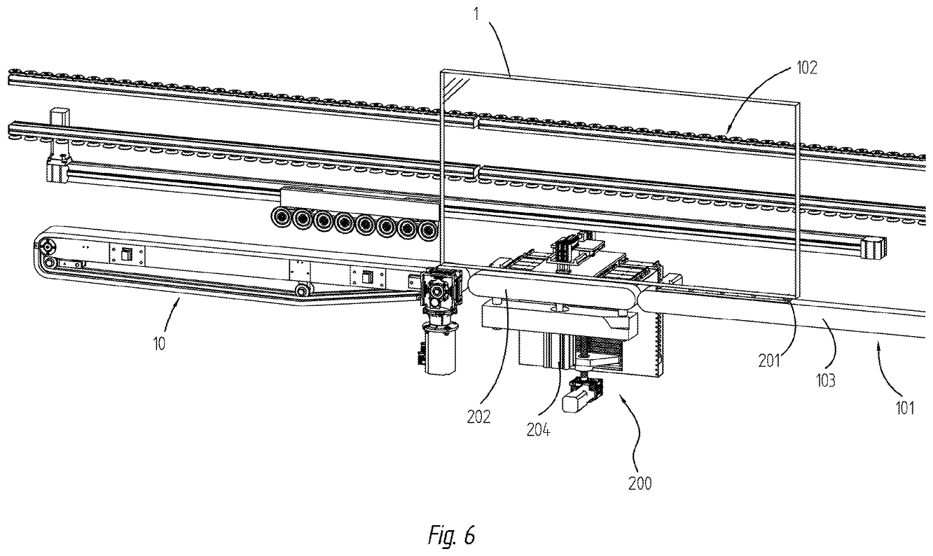

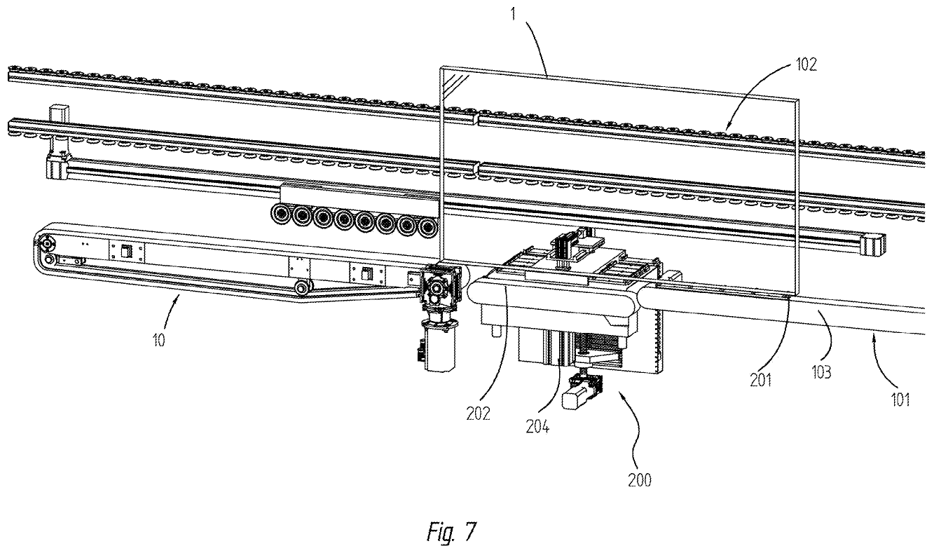

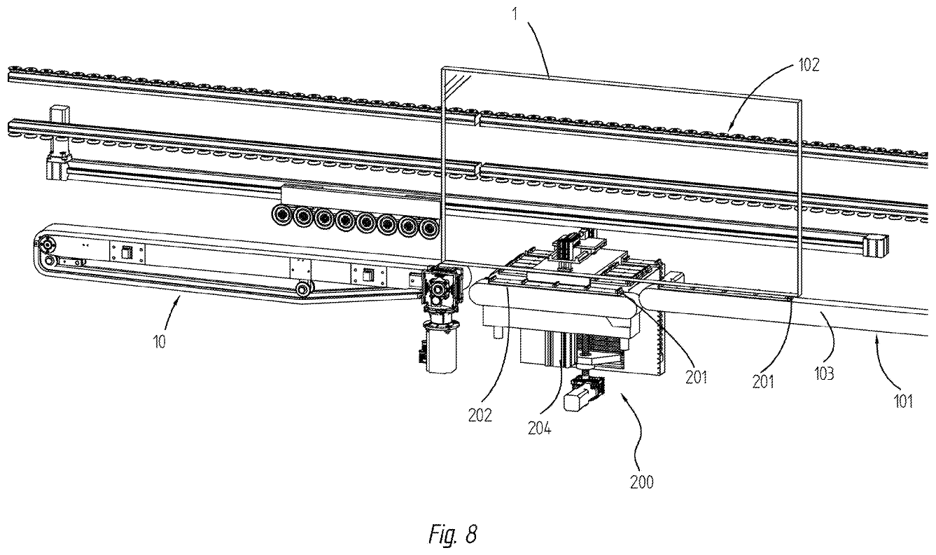

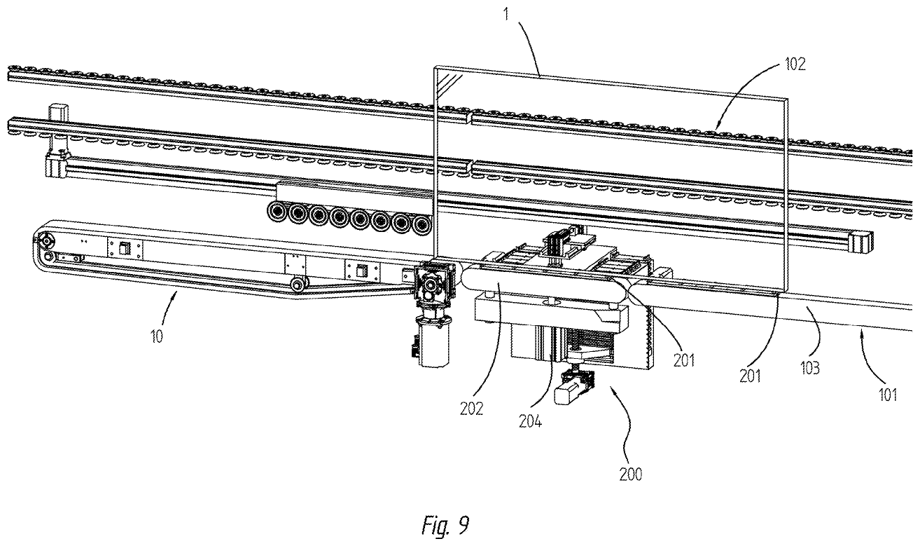

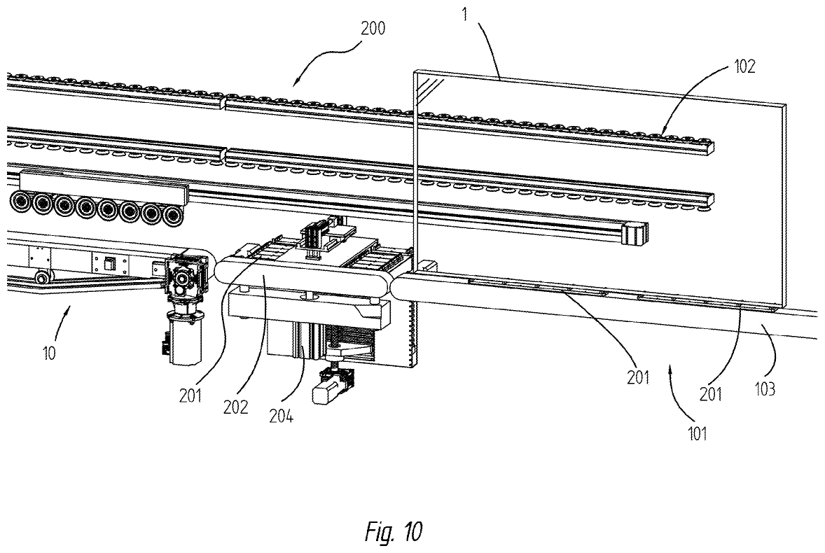

According to a possible embodiment, the process for unloading the insulating glass 1 from the production line 10, and for the operations of transporting, storing, and reorganizing it performed by the automated system 100, can comprise the steps of:
positioning the insulating glass 1 on the conveyor 11 at the outlet of the end part 10 of the production line (FIG. 2);
positioning the conveyor 202 in the lowered position thereof (FIG. 2);
positioning a separating means above the 201 conveyor 202 (FIG. 3);
advancing, by actuating the conveyor 11 of the insulating glass 1, partially above the conveyor 202;
lifting the conveyor 202 to the lifted position thereof up to bringing the separating means 201 into contact with the lower part of the insulating glass 1 (FIG. 5);
advancing the insulating glass 1 to place it partially above the conveyor 101 (FIG. 6). Such a step is carried out by the coordinated actuation of the conveyors 11, 202 and 101;
lowering the conveyor 202 up to the lowered position thereof (FIG. 7);
inserting a further separating means 201 above the conveyor 202 (FIG. 8);
lifting the conveyor 202 again to the lifted position thereof up to bringing the separating means 201 into contact with the lower part of the insulating glass 1 (FIG. 9);
advancing the insulating glass 1 by the coordinated actuation of conveyor 202 and conveyor 101;
continuing the transport of the insulating glass 1 towards the subsequent conveyors 101 and loading, by means of the shuttle 120, onto a free compartment of the storage module 140;
managing the standby time of the insulating glass 1 in the storage module for reaching the conditions required for the subsequent movement, packaging, and shipment steps;
possible subsequent movement operations of the insulating glass 1 by the shuttle(s) 120 in order to reorganize the insulating glass 1 in the storage module 140;
withdrawing the insulating glass 1 from the storage module 140 and transporting it to the conveyor(s) 101′;
releasing the insulating glass 1 onto the conveyor(s) 160 for the manual or automated unloading and packaging operations.

The sequence described above can also be modified, for example, by advancing the insulating glass 1 while the positioning device 205 places the separating means on the conveyor 202.

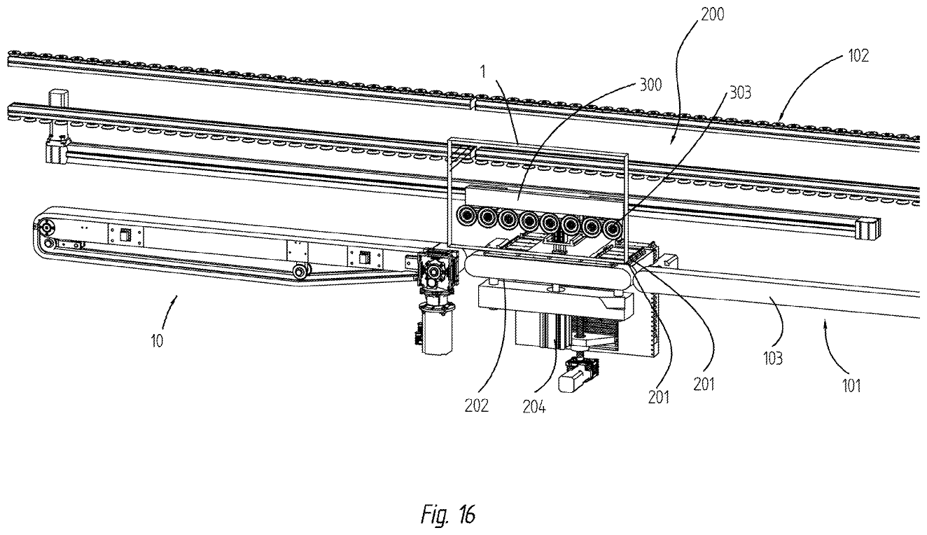

Since the control unit 170 has all the geometry and composition data of the insulating glass 1 in transit, it is capable of calculating the position of the centre of gravity thereof and accordingly, based also on the length thereof, the dimensions of conveyor 202, and the distance between conveyor 11 and conveyor 101, can assess the risk that the insulating glass 1 is not properly supported by the conveyors 11 and 101 in all the transit steps on the conveyor 202. If such a risk is assessed, as shown in FIG. 16, before the insulating glass 1 transits on the conveyor 202, it can be coupled by the coupling means 303 of carriage 300 and supported thereby during all the steps of the process.

Likewise, since the length of the insulating glass is known, the control unit 170 can be capable of determining if a single separating means alone is sufficient or if it is necessary, as occurs in most cases, to insert more than one separating means between the conveyors 101 and the insulating glass 1.

The case can occur in which the separating means 201 protrude(s) at the head or tail, past the length of the insulating glass 1: the control unit 170 can manage the movements of such an insulating glass 1 by taking such information into account.

The positioning of the separating means 201 with respect to the insulating glass 1 can also be determined by the control unit 170 to minimize the bending and cutting stresses to which the insulating glass 1 is subjected during the movements.

Moreover, again through the available information, the control unit 170 can be capable of determining the time required for each insulating glass to reach the condition to be unloaded by system 100, to be made available for the subsequent steps of the production process or for shipping. Such a time interval indeed depends on the type of spacer and sealants used, on environmental conditions such as moisture and temperature, and on the amount of sealants used. This functionality allows optimizing the crossing time of each insulating glass 1 or each order comprising several pieces of insulating glass 1 in order to make the whole logistics management more efficient and reduce production costs.

Advantageously, in a possible alternative embodiment, more than one automatic loader 203 and more than one positioning device 205 can be used, each dedicated to a different type of separating means, for example for different lengths. The control unit 170 can thus decide which size of separating means 201 to use according to the dimensions of the insulating glass in transit. Different materials can also be used to manufacture the separating means 201 so that the most appropriate one can be used again as a function of the features of the insulating glass 1. There are several possible configurations for the arrangement of more than one automatic loader 203 and more than one positioning device 205 known to those skilled in the art such as the arrangement in series using further conveyors 202, or in parallel arranged over several planes so as to use a single conveyor 202, however provided with several positioning heights, one for each positioning device 205.

As is known to those skilled in the art, like for the movement, storage and reorganization systems of the individual glass sheets which are well known and have been applied for years, several configurations are also possible for the system 100 described, which stand out from one another for size, amount of shuttles 120 used, amount of storage modules 140, etc. It can be said that such types of systems are defined based on the specific needs of each individual end customer, the features thereof being dependent, for example, on the available space, type of products, production capacity, etc.

The present invention is susceptible to several constructional variants, all falling within the scope of the equivalence with the inventive concept, such that, for example and in particular, the mechanical solutions implemented for the conveyors 101, 101′, 160 and 202 can be of the belt or roller type, moved by different types of kinematic systems known to those skilled in the art, as well as the wheels 104 used to support the insulating glass 1 in an almost vertical position can be replaced by air cushion systems, the length of the separating means can vary again based on the specific needs of the customer, the means for actuating the various movements can be electric, electric-electronic, pneumatic, hydraulic, and/or combined, etc.

In order to meet specific needs, those skilled in the art may make changes to the embodiments described above or replace the elements described with equivalent elements without departing from the scope of the appended claims.

1. An apparatus for unloading insulating glass panels from a production line comprising an insertion device provided with a conveyor adapted to transport the insulating glass panels according to a transit direction (x) from an entrance area near the production line to an exit area for said insulating glass panels; and a vertical support structure for keeping the insulating glass panels in an inclined position with respect to a vertical direction, wherein in said insertion device, separating means are positioned above said conveyor, so that the separating means can be interposed between said insulating glass panels and said conveyor.

2. The apparatus of claim 1, further comprising a positioning device adapted to position said separating means above said conveyor.

3. The apparatus of claim 2, wherein said insertion device comprises handling means for said conveyor between a transport position for said insulating glass panels and a lowered position with respect to the transport position, for inserting said separating means by the positioning device.

4. The apparatus of claim 3, wherein said handling means comprise an electric, electro-pneumatic, pneumatic, hydraulic and/or combined lift cylinder.

5. The apparatus of claim 2, wherein said positioning device comprises:
a support plate, on which a plurality of the separating means can be positioned side by side and substantially oriented parallel to the transit direction (x) of said insulating glass panels; and
a shaped upper plate provided with at least one longitudinal seat facing said support plate, adapted to at least partially contain at least one separating means, said shaped upper plate being adapted to be moved:
(a) closer to and farther from said support plate to engage at least one separating means on command; and
(b) in a transverse direction above said support plate, to move said at least one separating means towards said conveyor.

6. The apparatus of claim 5, wherein said positioning device comprises actuating means which allow the movements (a) and (b).

7. The apparatus of claim 2, wherein said insertion device comprises an automatic loader adapted to automatically feed the positioning device.

8. The apparatus of claim 7, wherein said automatic loader comprises handling means comprising a motorisation connected to a reducer which drives a worm screw, adapted to move a loader support on which the separating means can be stacked, so that the stack of separating means can be lifted to bring a next one of the stack of separating means to a height of the support plate to be translated by the positioning device.

9. The apparatus of claim 1, wherein the vertical support structure of said insertion device comprises a carriage with coupling means, preferably a plurality of suction cups.

10. The apparatus of claim 1, further comprising a storage module for said insulating glass panels coming from said insertion device comprising a plurality of panel warehouses, arranged along a direction (z) substantially perpendicular to said transit direction (x).

11. The apparatus of claim 10, further comprising:
at least one conveyor adapted to receive the insulating glass panels from said insertion device, and adapted to be moved according to the transit direction (x);
at least one shuttle adapted to receive the insulating glass panels from said at least one conveyor and serve said storage module, said at least one shuttle being adapted to translate in front of said panel warehouses along the direction (z); and
at least one withdrawal conveyor adapted to receive the insulating glass panels from said at least one shuttle.

12. The apparatus of claim 1, further comprising at least one unloading conveyor comprising retaining means for detaching the separating means from the insulating glass panels before removal thereof from the at least one unloading conveyor.

13. The apparatus of claim 12, wherein said retaining means comprise at least one parallel pneumatic gripper adapted to actuate jaws to retain the separating means during lifting of the insulating glass panels from the separating means.

14. The apparatus of claim 1, wherein said separating means comprise a substantially rigid element adapted to be reused.

15. The apparatus of claim 1, wherein said separating means comprise a substantially rectangular elongated element arranged provided with support inserts adapted to support at least one insulating glass panel.

16. The apparatus of claim 15, wherein said elongated element is made of polymeric material, preferably PVC (polyvinyl chloride), and/or said support inserts are made of polymeric material, preferably nitrile rubber.

17. The apparatus of claim 15, wherein said elongated element is made by coupling two different materials: a lower layer with a high friction coefficient, preferably nitrile rubber, and an upper layer in non-stick material, preferably teflon, even more preferably an insert is interposed between the two layers of material which is adapted to confer mechanical stiffness features to the separating means.

18. The apparatus of claim 1, further comprising side wheels for lateral guidance of the separating means during transit on the conveyors.

19. The apparatus of claim 1, further comprising means for applying a non-stick substance to said separating means before the separating means are used.

20. The apparatus of claim 1, further comprising a programmable control unit, operatively connected to drives of the apparatus for managing movements of components of the apparatus.

21. A plant comprising a production line of insulating glass and the apparatus for unloading insulating glass panels from the production line of claim 1.

22. A process for unloading insulating glass panels from a production line, the process comprising steps of:
(a) providing an apparatus for unloading the insulating glass panels from the production line comprising an insertion device provided with a conveyor adapted to transport the insulating glass panels according to a transit direction (x) from an entrance area near the production line to an exit area for said insulating glass panels; and a vertical support structure for keeping the insulating glass panels in an inclined position with respect to a vertical direction, wherein in said insertion device separating means are positioned above said conveyor, so that the separating means can be interposed between said insulating glass panels and said conveyor;
(b) positioning a separating means above said conveyor;
(c) advancing an insulating glass panel above the separating means; and
(d) advancing the insulating glass panel supported by at least one separating means towards the conveyor.

23. The process of claim 22, further comprising:
a step (b′) before step (b) in which the conveyor is positioned in a lowered insertion position of said separating means; and
a step (c′) after step (c), in which the conveyor is lifted to a transport position until the separating means are brought into contact with a lower part of the insulating glass panel.

24. The process of claim 22, wherein the vertical support structure of said insertion device comprises a carriage with coupling means, and wherein during transit of the insulating glass panel on the conveyor, the insulating glass panel is supported by the coupling means of the carriage.

25. The process of claim 23, wherein at least one further separating means is inserted between the conveyor and the insulating glass panel, through repetition of steps (b) and (c), and possibly also of steps (b′) and (c′).

26. The process of claim 22, further comprising a step of applying a non-stick substance on the separating means.

27. The process of claim 22, further comprising a step of rearranging the insulating glass panels according to specific needs.

28. The process of claim 22, further comprising a step in which the insulating glass panels remain in a storage module until the insulating glass panels are ready for subsequent steps and/or for shipping.
